(19) United States
(12) Patent Application Publication
(10) Pub. No.: US 2013/0297599 A1
(43) Pub. Date: Nov. 7, 2013

(54) MUSIC MANAGEMENT FOR ADAPTIVE DISTRACTION REDUCTION

(71) Applicant: Dulcetta Inc., Los Angeles, CA (US)

(72) Inventor: William Russell Henshall, Los Angeles, CA (US)

(21) Appl. No.: 13/843,585

(22) Filed: Mar. 15, 2013

Related U.S. Application Data
(63) Continuation-in-part of application No. 12/943,917, filed on Nov. 10, 2010, now Pat. No. 8,527,859.
(60) Provisional application No. 61/259,995, filed on Nov. 10, 2009.

(51) Int. Cl. G06F 17/30

(52) U.S. Cl. CPC G06F 17/30743
USPC 707/736

(57) ABSTRACT

An example embodiment involves creating a playlist of audio tracks, wherein the playlist comprises a plurality of segments, and selecting audio tracks for each segment, wherein the audio tracks comprising each particular segment are related to each other by at least one property of the audio tracks' musical composition. Points, based upon input data, are defined in the playlist at which each segment will begin playing, and at each defined point, a particular segment wherein the at least one property of the audio tracks comprising the particular segment is different from the at least one property of the audio tracks comprising the previously-played segment is played.

### CLAIM OF PRIORITY AND RELATED APPLICATION DATA

This application is a continuation-in-part of, and claims priority to, U.S. non-provisional patent application Ser. No. 12/943,917, filed Nov. 10, 2010, entitled “Dynamic Audio Playback of Soundtracks for Electronic Visual Works,” the contents of which are hereby incorporated by reference for all purposes as if fully set forth herein.

Note that U.S. non-provisional patent application Ser. No. 12/943,917 claims priority to US. Provisional patent application Ser. No. 61/259,995, filed on Nov. 10, 2009, the contents of which are hereby incorporated by reference for all purposes as if fully set forth herein.

### BACKGROUND

Many people listen to music while reading, often in an attempt to reduce distractions in their environment. For example, a person may be reading a dense novel in a loud, crowded café and wish to concentrate on the text, so they slip on headphones and listen to music in an effort to drown out the distracting noises. Often, the music chosen by the reader can be as distracting as the noise surrounding them, or at least be poorly matched with the content they are reading or with their purpose for reading. For example, listening to death metal while trying to read sad poetry would likely not enhance the reader's concentration and reduce distraction; rather, it would make getting into a “flow” state of high concentration more difficult.

### BRIEF DESCRIPTION OF THE DRAWINGS

Embodiments of the invention are illustrated by way of example, and not by way of limitation, in the figures of the accompanying drawings and in which like reference numerals refer to similar elements and in which:

FIG. 1 is a dataflow diagram of an electronic book reader with a dynamic audio player.

FIG. 2 is a dataflow diagram of more details of the dynamic audio player of FIG. 1.

FIG. 3 is an illustration of a cue list.

FIG. 4 is an illustration of an audio cue file.

FIG. 5 is a flow chart of the setup process when an electronic book is opened.

FIG. 6 is a flow chart describing how an audio cue file is used to create audio data of a desired duration.

FIG. 7 is a flow chart describing how reading speed is calculated.

FIG. 8 is a data flow diagram describing how a soundtrack can be automatically generated for an electronic book;

FIG. 9 is a block diagram 900 illustrating an example system 902 for the presentation and/or delivery of audio works that may be consumed along with electronic content, as well as an example system for the authoring of such combined works that may be delivered to an external device;

FIG. 10 is a diagram 1000 illustrating an example representation of a productivity cycle with an embodiment of multiple phases of musical selections being played which are designed to sustain a flow state even as habituation to the musical selections is occurring;

FIG. 11 is a flow diagram illustrating an example process 1100 for creating an audio playlist for distraction reduction;

FIG. 12 is a is a block diagram 1200 illustrating an example system 1202 for real-time adaptive distraction reduction, according to an embodiment; and

FIG. 13 is a block diagram that illustrates a computer system upon which an embodiment of the invention may be implemented.

### DETAILED DESCRIPTION OF THE INVENTION

Approaches for creating and managing music playlists for distraction reduction are presented herein. In the following description, for the purposes of explanation, numerous specific details are set forth in order to provide a thorough understanding of the embodiments of the invention described herein. It will be apparent, however, that the embodiments of the invention described herein may be practiced without these specific details. In other instances, well-known structures and devices are shown in block diagram form or discussed at a high level in order to avoid unnecessarily obscuring teachings of embodiments of the invention.

### Functional Overview

Embodiments of the approach may comprise creating a playlist of audio tracks, wherein the playlist comprises a plurality of segments, and then selecting audio tracks for each segment, wherein the audio tracks comprising each particular segment are related to each other by at least one property of the audio tracks' musical composition. Points are defined in the playlist at which each segment will begin playing, and each point is based upon input data. At each defining point, a particular segment is played wherein the at least one property of the audio tracks comprising the particular segment is different from the at least one property of the audio tracks comprising the previously-played segment.

### Audio Playback Associated with Electronic Visual Works

Soundtracks can be associated with any of a variety of electronic visual works, including electronic books. The types of music or audio that could be used also likely would depend on the type of work. For example, for works of fiction, the soundtrack will be similar in purpose to a movie soundtrack, i.e., to support the story—creating suspense, underpinning a love interest, or reaching a big climax. For children's books, the music may be similar to that used for cartoons, possibly including more sound effects, such as for when a page is being turned. For textbooks, the soundtrack may include rhythms and tonalities known to enhance knowledge retention, such as material at about 128 or 132 beats per minute and using significant modal tonalities. Some books designed to support meditation could have a soundtrack with sounds of nature, ambient sparse music, instruments with soft tones, and the like. Travel books could have music and sounds that are native to the locations being described. For magazines and newspapers, different sections or articles could be provided with different soundtracks and/or with different styles of music. Even reading different passes of the same page could have different soundtracks. Advertisers also could have their audio themes played during reading of such works. In such cases, the soundtracks could be selected in a manner similar to how text based advertisements are selected to accompany other material.

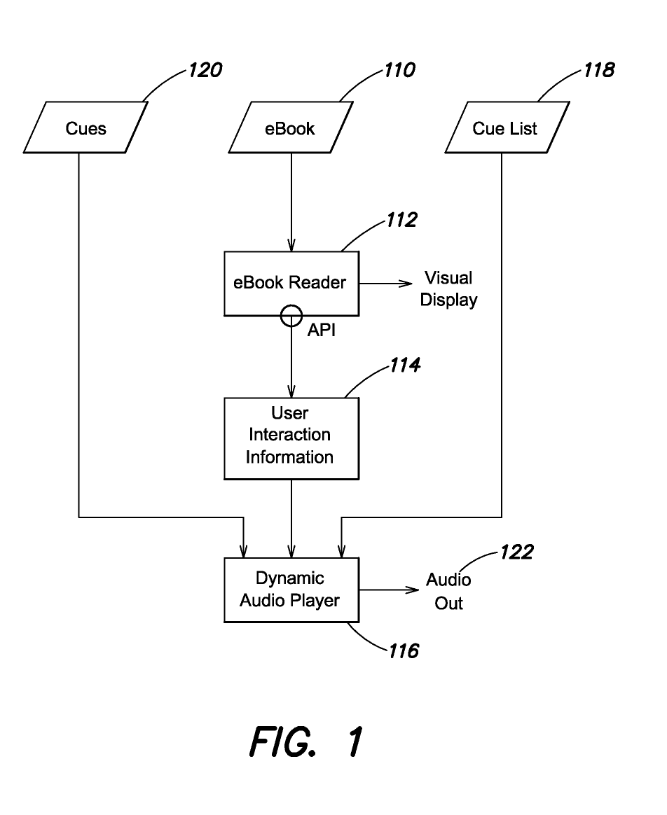

In particular, referring now to FIG. 1, electronic content such as an electronic book 110 is input to an electronic device such as an electronic book reader 112, which provides a visual display of the electronic book to an end user or reader. The electronic content may also comprise any external content, such as a web page or other electronic document; therefore, the term electronic book in the present disclosure may encompass other types of electronic content as well. The electronic device may also comprise any device capable of processing and/or displaying electronic content, such as a computer, tablet, smartphone, portable gaming platform or other device; therefore, the term electronic book reader in the present disclosure may encompass other types of electronic devices as well. The electronic book 110 is one or more computer data files that contain at least text and are in a file format designed to enable a computer program to read, format and display the text. There are various file formats for electronic books, including but not limited to various types of markup language document types (e.g., SGML, HTML, XML, LaTex and the like), and other document types, examples of which include, but are not limited to, EPUB, FictionBook, plucker, PalmDoc, zTxt, TCR, CHM, RTF, OEB, PDF, mobipocket, Calibre, Stanza, and plain-text. Some file formats are proprietary and are designed to be used with dedicated electronic book readers. The invention is not limited to any particular file format.

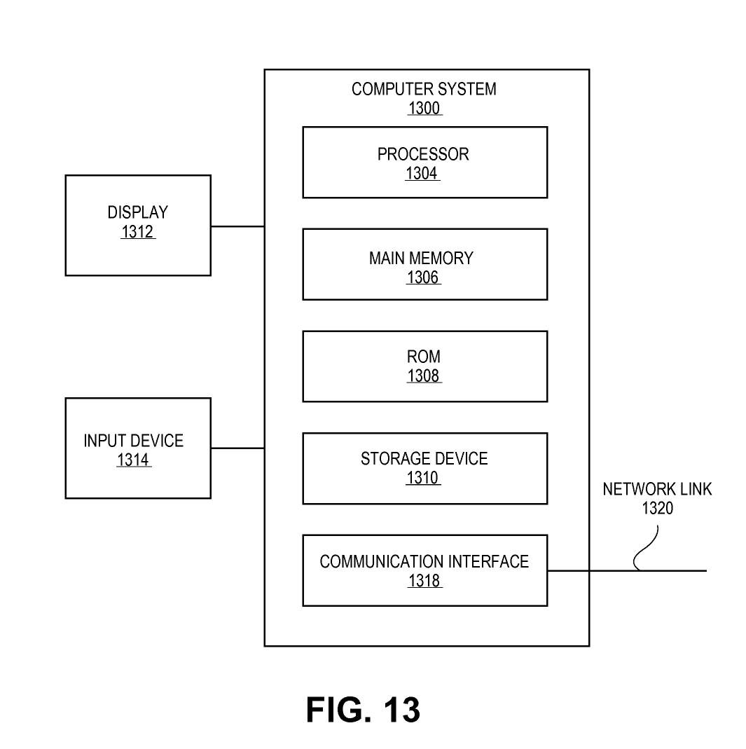

The electronic book reader 112 can be any computer program designed to run on a computer platform, such as described above in connection with FIG. 13, examples of which include, but are not limited to, a personal computer, tablet computer, mobile device or dedicated hardware system for reading electronic books and that receives and displays the contents of the electronic book 110. There are a number of commercially or publicly available electronic book readers, examples of which include, but are not limited to, the KINDLE reader from Amazon.com, the Nook reader from Barnes & Noble, the Stanza reader, and the FBReader software, an open source project. However, the invention is not limited to any particular electronic book reader.

The electronic book reader 112 also outputs data 114 indicative of the user interaction with the electronic book reader 112, so that such data can be used by a dynamic audio player 116. Commercially or publicly available electronic book readers can be modified in accordance with the description herein to provide such outputs.

The data about the user interaction with the text can come in a variety of forms. For example, an identifier of the book being read (such as an ISBN, e-ISBN number or hash code), and the current position in the text can be provided. Generally, the current position is tracked by the electronic book reader as the current “page” or portion of the electronic book that is being displayed. The electronic book reader can output this information when it changes. Other information that can be useful, if provided by the electronic book reader 112, includes, but is not limited to the word count for a current range of the document being display, an indication of when the user has exited the electronic book reader application, and an indication of whether the reader has paused reading or resumed reading after a pause.

The information and instructions exchanged between the electronic book reader and the dynamic audio player can be implemented through an application programming interface (API), so that the dynamic audio player can request that the electronic book reader provide status information, or perform some action, or so that the electronic book reader can control the other application program. The dynamic audio player can be programmed to implement this API as well. An example implementation of the API includes, but is not limited to, two interfaces, one for calls from the electronic book reader application, and another for calls to the electronic book reader application.

Example calls that the electronic book reader can make to the dynamic audio player include:

“ebookOpenedwithUniqueID” —This function is called by the electronic book reader when the application opens an electronic book. This function has parameters that specify the electronic book's unique identifier and whether the electronic book has been opened before. In response to this information the dynamic audio player sets the current cue. The first time an electronic book is opened, the current position will be set to the start of the first cue.

“ebookClosed” —This function is called by the electronic book reader when the application closes an electronic book. In response to this call, the dynamic audio player can free up memory and reset internal data.

“ebookRemoved” —This function is called when the electronic book reader has removed an ebook from its library, so that soundtrack and audio files also can also be removed.

“displayedPositionRangeChanged” —This function is called when the electronic book reader changes its display, for example, due to a page turn, orientation change, font change or the like, and provides parameters for the range of the work that is newly displayed. In response to this call the dynamic audio player can set up audio cues for the newly displayed range of the work.

“readingResumed” —This function is called when the user has resumed reading after an extended period of inactivity, which the electronic book reader detects by receiving any of a variety of inputs from the user (such as a page turn command) after reading has been determined to be “paused.”

“fetchSoundtrack” —This function is called by the electronic book reader to instruct the dynamic audio player to fetch and import the soundtrack file, or cue list, for the electronic book with a specified unique identifier (provided as a parameter of this function).

“audioVolume” —This function is called by the electronic book reader to instruct the dynamic audio player to set the volume of the audio playback.

“getCueLists” —This function is called by the electronic book reader to retrieve information from the dynamic audio player about the cue lists and groups available for the currently opened electronic book. This function would allow the electronic book reader to present this information to the reader, for example.

“cueListEnabled” —This function is called by the electronic book reader to instruct the dynamic audio player to enable or disable a particular cue list, e.g., an alternative soundtrack, sound effects, a recorded reader or text-to-speech conversion.

“audioIntensity” —This function is called by the electronic book reader to instruct the dynamic audio player to set the intensity of the audio playback, e.g., to make the audio composition quieter or mute a drum stem (submix).

“audioPreloadDefault” —This function is called to set a default number of hours of audio to download and keep on hand generally for electronic books.

“audioPreloadForEbook” —This function is called to set a number of hours of audio to download and keep for a specific ebook.

“downloadEnabled” —This function is called to enable or disable audio downloading.

Example calls that the dynamic audio player can make to the electronic book reader include:

“readingPaused” —This function is called by the dynamic audio player if it has not received a “displayedPositionRangeChanged” call from the electronic book reader within an expected time. From this information, it is assumed by the dynamic audio player that the user is no longer reading. After calling this function, the electronic book reader should call the “readingResumed” function when the user starts reading again.

“gotoPosition” —This function is called by the dynamic audio player to instruct the electronic book reader to set the current position in the book, usually at the start point of the first cue the first time the electronic book is opened in response to the “ebookOpenedAtPath” function being called.

“wordCountForRange” —This function is called by the dynamic audio player to instruct the electronic book reader to provide a number of words for a specified range of the electronic book, to be used in scheduling playlists and tracking reading speed as described in more detail below.

The use of these API calls is described in more detail below.

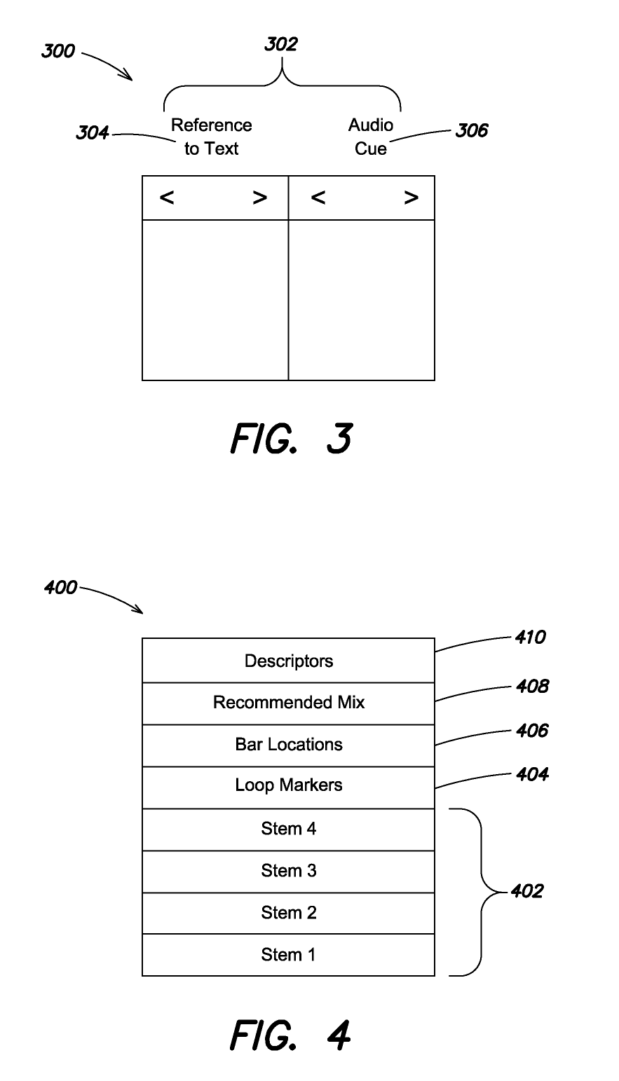

The electronic book 110 has an associated cue list 118, described in more detail below in connection with FIG. 3, which associates portions of the text with audio cues 120. In general, an identifier used to uniquely identify the electronic book 110 is used to associate the cue list 118 to the book by either embedding the identifier in the cue list or having a form of lookup table or map that associates the identifier of the book with the cue list 118. An audio cue 120 is a computer data file that includes audio data. In general, an audio cue 120 associated with a portion of the text by the cue list 118 is played back while the reader is reading that portion of the text. For example, a portion of the text may be designated by a point in the text around which the audio cue should start playing, or a range in the text during which the audio cue should play. The dynamic audio player 116 determines when and how to stop playing one audio cue and start playing another.

The dynamic audio player 116 receives data 114 about the user interaction with the electronic book reader 112, as well as cues 120 and the cue list 118. As will be described in more detail below, the dynamic audio player 116 uses the user interaction data 114 and the cue list 118 to select the audio cues 120 to be played, and when and how to play them, to provide an output audio signal 122.

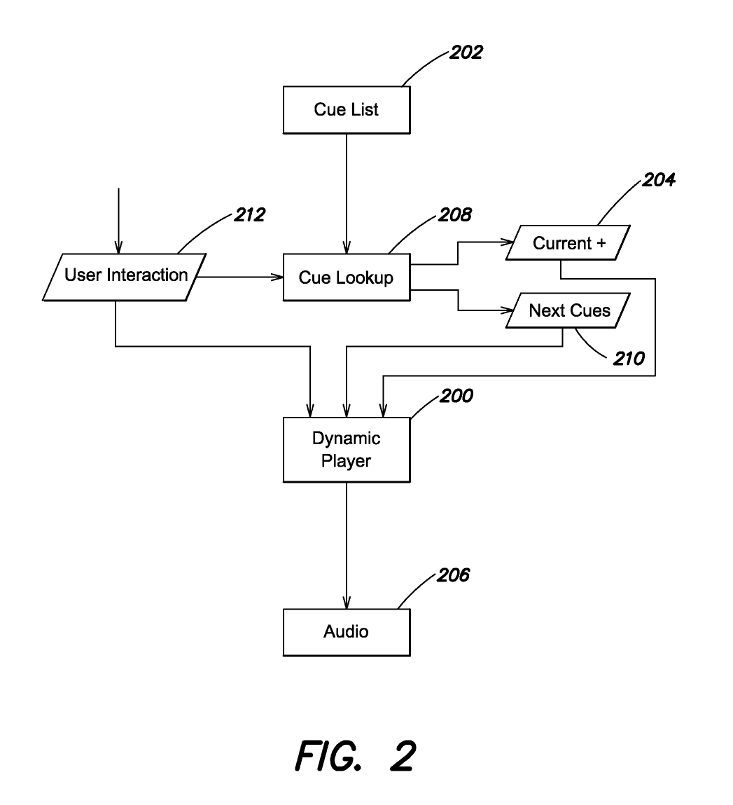

During playback of the soundtrack, the dynamic audio player plays a current cue, associated with the portion of the text currently being read, and determines how and when to transition the next cue to be played, based on the data about the user interaction with the text. As shown in more detail in FIG. 2, the dynamic audio player 200 thus uses a current cue 204 and a next cue 210 to generate audio 206. The cues 204 and 210 to be played are determined through a cue lookup 208, using the data 212 about the user interaction, and the cue list 202. While the dynamic audio player is playing the current cue 204, it monitors the incoming data 212 to determine when the next cue should be played. The current cue 204 may need to be played for a longer or shorter time than the cue's actual duration. As described in more detail below, the dynamic audio player lengthens or shortens the current cue so as to fit the amount of time the user is taking to read the associated portion of the text, and then implements a transition, such as a cross fade, at the estimated time at which the user reaches the text associated with the next cue.

Referring now to FIG. 3, an example implementation of the cue list 118 of FIG. 1 will now be described in more detail. Audio cues, e.g., 120 in FIGS. 1 and 204, 210 in FIG. 2, are assigned to portions of the text. This assignment can be done using a meta-tag information file that associates portions of the text with audio files. The association with an audio file may be direct or indirect, and may be statically or dynamically defined. For example, different portions of the text can be assigned different words or other labels indicative of emotions, moods or styles of music to be associated with those portions of the text. Audio files then can be associated with such words or labels. The audio files can be selected and statically associated with the text, or they can be selected dynamically at the time of playback, as described in more detail below. Alternatively, different points in the text may be associated directly with an audio file.

An example meta-tag information file is shown in FIG. 3. The meta-tag information file is a list 300 of pairs 302 of data representing a cue. Each pair 302 representing a cue includes a reference 304 to the text, such as a reference to a markup language element within a text document, an offset from the beginning of a text document, or a range within a text document. The pair 302 also includes data 306 that specifies the cue. This data may be a word or label, such as an emotive tag, or an indication of an audio file, such as a file name, or any other data that may be used to select an audio file. How a composer or a computer program can create such cue lists will be described in more detail below.

The meta-tag information file can be implemented as a file that is an archive containing several metadata files. These files can be in JavaScript Object Notation (JSON) format. The meta-tag information file can include a manifest file that contains general information about the soundtrack, such as the unique identifier of the electronic book with which it is associated, the title of the electronic book, a schema version, (for compatibility purposed, in case the format changes in the future), and a list of other files in the archive, with checksums for integrity checking. In addition to the manifest file, the meta-tag information file also includes a cuelists file which contains the list of cue list descriptors available in the soundtrack. Each cue list descriptor includes a display name, a unique identifier for lookup purposes and an optional group name of the cue list. As an example, there may be several mutually exclusive main cue lists, from which it only makes sense to have a single one playing. These cue lists might have a group name of “main,” whereas with a sound effects or “read to me” cue list it would be ok to play them all at that same time, and thus would not utilize the group name.

The meta-tag information file also includes a cues file that contains the list of cue descriptors for all of the cue lists. Each cue descriptor includes a descriptive name given to the cue descriptor by a producer. This descriptor could be entered using another application for this purpose, and could include information such as a cue file name that is used to look up the location of the cue file in the list of cue files, and in and out points in the electronic book.

Finally, the meta-tag information file includes a “cuefiles” file that contains the list of cue file descriptors. The cuefiles file specifies the network location of the cue files. Each cue file descriptor includes a descriptive name given to the cuefile by a producer and used as the cue file name in the cue descriptor, a uniform resource locator (URL) for retrieving the cue file and the original file name of the cue file.

The audio cues (120 in FIG. 1) referred to in such a cue list contain audio data, which may be stored in audio file formats, such as AIFF, MP3, AAC, m4a or other file types. Referring now to FIG. 4, an example implementation of an audio cue file will be described. An audio cue file 400 can include multiple “stems” (submixes) 402, each of which is a separate audio file that provides one part of a multipart audio mix for the cue. The use of such stems allows the dynamic audio player to select from among the stems to repeat in order to lengthen the playback time of the cue. An audio cue file also can include information that is helpful to the dynamic audio player to modify the duration for which the audio cue is played, such as loop markers 404, bar locations 406 and recommended mix information 408. The recommended mix information includes a list of instructions for combining the audio stems, where each instruction indicates the stems and sections to be used, and any audio effects processing to be applied. Other information such as a word or label indicative of the emotion or mood intended to be evoked by the audio or data indicative of genre, style, instruments, emotion, atmosphere, place, era—called descriptors 410—also can be provided. Even more additional information, such as alternative keywords, cue volume, cross-fade or fade-in/out shape/intensity and recommended harmonic progression for successive cues also can be included.

As an example, the audio cue file can be implemented as an archive containing a metadata file in JSON format and one or more audio files for stems of the cue. The metadata file contains a descriptor for the metadata associated with the audio files, which includes bar locations, loop markers, recommended mix information, emodes (emotional content meta-tags), audio dynamics control metadata (dynamic range compression), instruments, atmospheres and genres. The audio files can include data compressed audio files and high resolution original audio files for each stem. Retaining the high resolution versions of each stem supports later editing using music production tools. A copy of the audio cue files without the original audio files can be made to provide for smaller downloads to electronic book readers. The cue file contains the compressed audio files for the stems, which are the files used for playback in the end user applications.

The cue files can be created using a software tool that inputs a set of standard audio stems, adds descriptor, loop point and recommended mix meta information as a separate text file, optimizes and compresses the audio for network delivery and outputs a single package file that can be uploaded to a database. An audio file can be analyzed using various analytic techniques to locate sections, beats, loudness information, fades, loop points and the link. Cues can be selected using the descriptors “genre, style, instruments, emotion, place, era” and delivered over the network as they are used by the reader.

The cue lists and cue files can be individually encrypted and linked to a specific work for which they are the soundtrack. The same key would be used to access the work and its soundtrack. Thus files could be tied to the specific work or the specific viewing device through which the work was accessed, and can use digital rights management information associated with the work.

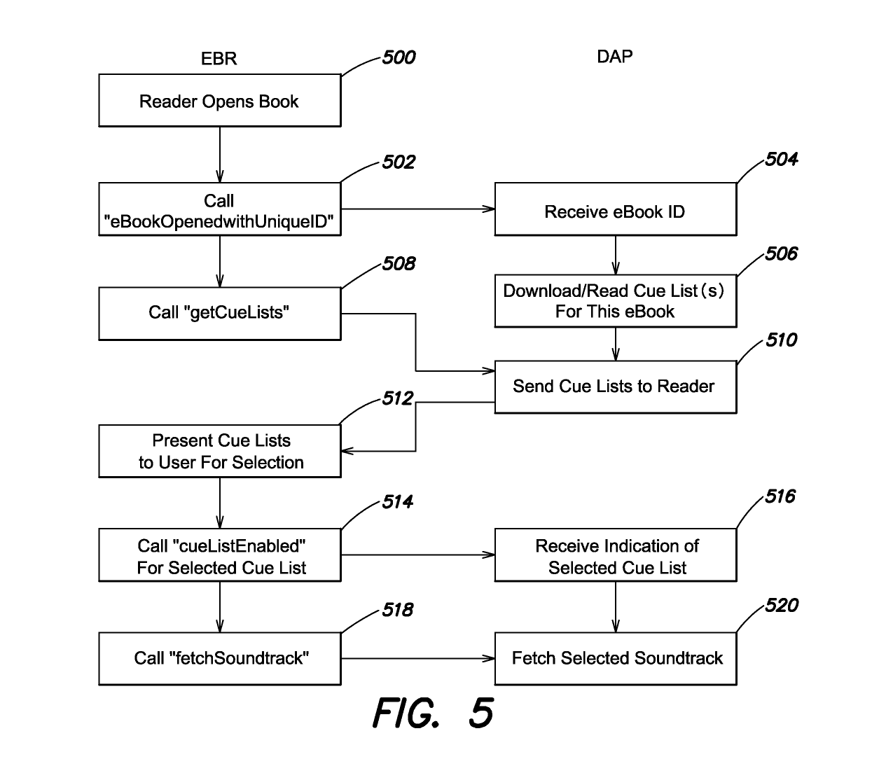

Given the foregoing understanding of cue lists, the audio cues, and the interaction available with the electronic book reader, the dynamic audio player will now be described in more detail in connection with FIGS. 5-7.

To initiate playback when a book is first opened (500) by a reader, the electronic book reader calls 502 the “ebookOpenedwithUniqueID” function, indicating the book's unique identifier and whether the book had been opened before. The dynamic audio player receives 504 the identifier of the electronic book, and downloads or reads 506 the cue list for the identified book. The electronic book reader prompts the dynamic audio player for information about the cue list, by calling 508 the “getCueLists” function. The dynamic audio player sends 510 the cue list, which the electronic book reader presents to the user to select 512 one of the soundtracks (if there is more than one soundtrack) for the book. Such a selection could be enhanced by using a customer feedback rating system that allows users to rate soundtracks, and these ratings could be displayed to users when a selection of a soundtrack is requested by the system. The “cueListEnabled” function is then called 514 to inform the dynamic audio player of the selected cue list, which the dynamic audio player receives 516 through the function call. The “fetchSoundtrack” function is called 518 to instruct the dynamic audio player to fetch 520 the cues for playback.

After this setup process completes, the dynamic audio player has the starting cue and the cue list, and thus the current cue, for initiating playback. Playback can be started at about the time this portion of the electronic book is displayed by the electronic book reader. The dynamic player then determines, based on the data about the user interaction with the book, the next cue to play, when to play the cue, and how to transition to the next cue from the current cue.

The dynamic audio player extends or shortens the playback time of a cue's audio stem files to fit the estimated total cue duration. This estimated cue duration can be computed in several ways. An example implementation uses an estimate of the reading speed, the computation of which is described in more detail below. The current cue duration is updated in response to the data that describes the user interaction with the electronic book reader, such as provided at every page turn through the “displayedPositionRangeChanged” function call.

In general, the playback time of a cue's audio stem files is modified by automatically looping sections of the audio stem files, varying the individual stem mixes and dynamically adding various effects such as reverb, delays and chorus. The loop points and other mix automation data specific to the audio stem files are stored in the cue file's metadata. There can be several different loop points in a cue file. The sections of the audio stems can be selected so that, when looped and remixed, they provide the most effective and interesting musical end user experience. This process avoids generating music that has obvious repetitions and maximizes the musical content to deliver a musically pleasing result that can have a duration many times that of the original piece(s) of audio. When the next cue is triggered, the transition between the outgoing and the incoming audio is also managed by the same process, using the cue file metadata to define the style and placement of an appropriate cross fade to create a seamless musical transition.

As an example, assume a cue file contains four audio stems (a melody track, a sustained chordal or “pad” track, a rhythmic percussive (often drums) track and a rhythmic harmonic track) that would run for 4 minutes if played in a single pass. Further assume that this recording has 3 distinct sections, A, B and C. The meta information in the cue file will include:

1. how to transition into the cue from a previous cue. This includes transition style (i.e., slow, medium or quick fade-in, or stop previous cue with reverb tail and start new cue from beginning of cue), musical bar and beat markers so that the cross fade will be musically seamless;

2. The time positions where each of the A, B and C sections can be looped.

3. The cue producer's input on how the 4 stems can be remixed. E.g., play stems 1, 2 and 3 only using section A, then play stems 1, 3 and 4 only using section A, add reverb to stem 3 and play it on its own using section B, then play stems 3 and 4 from section B, etc. Having these kinds of instructions means that a typical four minute piece of audio can be extended up to 40 or more minutes without obvious repetition. In addition, each mix is unique for the user and is created at the time of playback so unauthorized copying of the soundtrack is more difficult.

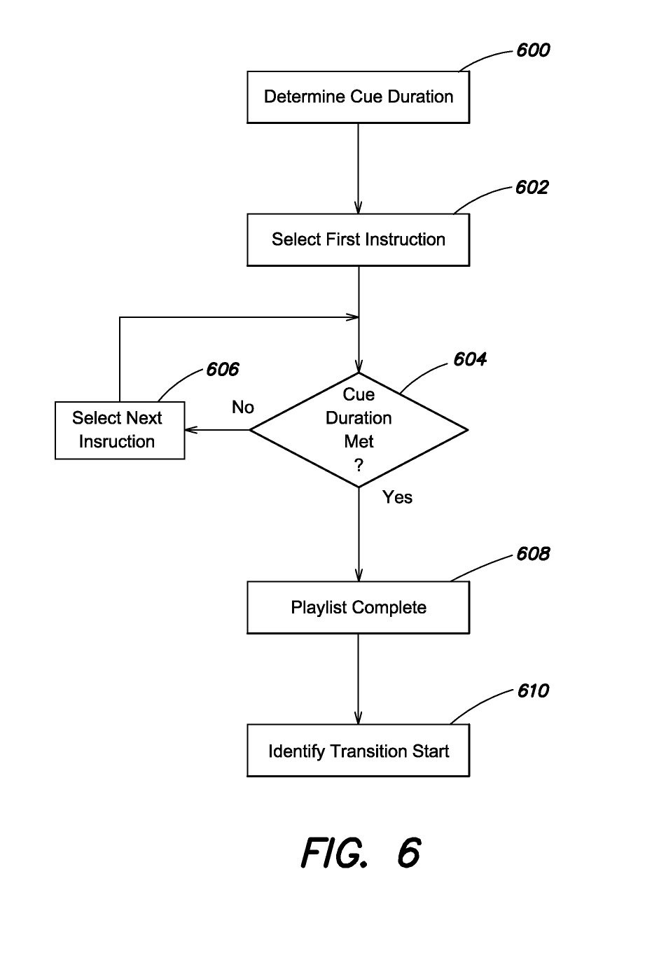

As an example, referring now to FIG. 6, this process will be described in more detail. Given a cue and a starting point, the duration of time until the next cue is to be played is determined (600). An example way to compute this duration is provided in more detail below. Given the duration, the cue producer's input is processed to produce a playlist of the desired duration. In other words, the first instruction in the remix information is selected 602 and added to playlist. If this section of the audio stems has a duration less than the desired duration, determined at 604, then the next instruction is selected 606, and the process repeats until a playlist of the desired duration is completed 608. At the end of the cue, the transition information in the metadata for the next cue is used to select 610 a starting point in the current playlist to implement a cross-fade from the current cue to the next cue.

One way to estimate the duration of a cue is to estimate the reading speed of the reader (in words per minute) and, given the number of words in the cue, determine how much time the reader is likely to take to complete reading this portion of the book. This estimate can be computed from a history of reading speed information for the reader.

When the user starts reading a book, an initial reading speed of a certain number words per minute is assumed. This initial speed can be calculated from a variety of data about a user's previous reading speed history from reading previous books, which can be organized by author, by genre, by time of day, by location, and across all books. If no previous reading history is available, then an anonymous global tally of how other users have read this title can be used. If no other history is available a typical average of 400 words per minute is used.

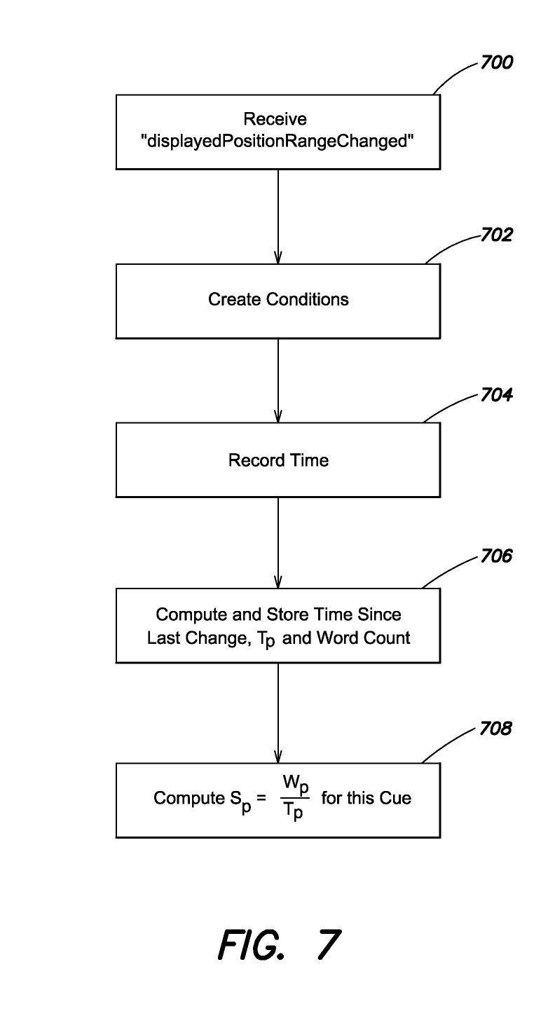

Referring now to FIG. 7, the reading speed for the user is tracked each time the displayed position range is changed, as indicated by the “displayedPositionRangeChanged” function call. If this function call is received (700), then several conditions are checked 702. These conditions can include, but are not limited to nor are all required: the user is actively reading, i.e., not in the reading paused state; the new displayed position range is greater than the previously displayed position range; the start of the newly displayed position range touches the end of the previously displayed position range; and the word count is above a minimum amount (currently 150 words). The time since the last change also should be within a sensible range, such as the standard deviation of the average reading speed to check the speed is within the normal expected variance. If these conditions are met, then the current time is recorded 704. The time since the last change to the displayed position range is computed and stored 706, together with the word count for the previously displayed position range. The reading speed for this section is computed 708. From this historic data of measured reading speeds, an average reading speed can be computed and used to estimate cue durations.

The formula for calculating the reading speed Sₚ (in words per second) for a page p is:

$${S}_{p} = \frac{{W}_{p}}{{T}_{p}}$$

where Wₚ is the word count for the page and Tₚ is the time taken to read the page, in seconds. In one implementation, the statistic used for the average reading speed is a 20 period exponential moving average (EMA), which smoothes out fluctuations in speed, while still considering recent page speeds more important.

The formula for calculating the EMA is:

$${M}_{0} = {S}_{0}$$

$${M}_{p} = \frac{n - 1}{n + 1} \times {M}_{p - 1} + \frac{2}{n + 1} \times {S}_{p}$$

Where n is the number of periods, i.e., 20.

To calculate the variance in reading speeds we use Welford's method for calculating variance, over the last 20 values:

Initialize M₁=T₁ and S₁=0

For subsequent values of T, use the recurrence formulas

$${M}_{k} = {M}_{k - 1} + \frac{{T}_{k} - {M}_{k - 1}}{k}$$

$${S}_{k} = {S}_{k - 1} + ( {T}_{k} - {M}_{k - 1} ) \times ( {T}_{k} - {M}_{k} )$$

For ≦k≦n the k^{th} estimate of the variance is:

$${S}^{2} = \frac{{S}_{k}}{k - 1} .$$

This reading speed information can be stored locally on the user's electronic book reader application platform. Such information for multiple users can be compiled and stored on a server in an anonymous fashion. The application could look up reading speed information statistics to determine how fast others have read a work or portions of a work.

Other types of user interaction instead of or in addition to reading speed can be used to control playback.

In one implementation, the data about the user interaction with the electronic book indicates that the reader has started reading from a point within the book. This happens often, as a reader generally does not read a book from start to finish in one sitting. In some cases, when a reader restarts reading at a point within the book, the audio level, or other level of “excitement,” of the audio in the soundtrack at that point might not be appropriate. That is, the audio could actually be distracting at that point. The dynamic audio player can use an indication that the reader has started reading from a position within the book as an opportunity to select an alternative audio cue from the audio cue that has been selected for the portion of the book that includes the current reading position.

As another example, the reader may be reading the book by skipping around from section to section. Other multimedia works may encourage such a manner of reading. In such a case, the audio cue associated with a section of a work is played when display of that section is initiated. A brief cross-fade from the audio of the previously displayed section to the audio for the newly displayed section can be performed. In some applications, where the nature of the work is such that the viewing time of any particular section is hard to predict, the dynamic playback engine can simply presume that the duration is indefinite and it can continue to generate audio based on the instructions in the cue file until an instruction is received to start another audio cue.

As another example, it is possible to use the audio cue files to playback different sections of a cue file in response to user inputs. For example, popular songs could be divided into sections. A user interface could be provided for controlling audio playback that would instruct the player to jump to a next section or to a specified section in response to a user input.

Having now described how such works and accompanying soundtracks can be created, their distribution will now be discussed.

Creating a soundtrack for an electronic book involves associating audio files with portions of the text of the electronic book. There are several ways in which the soundtrack can be created.

In one implementation, a composer writes and records original music for each portion of the text. Each portion of the text can be associated with individual audio files that are so written and recorded. Alternatively, previously recorded music can be selected and associated directly with the portions of the text. In these implementations, the audio file is statically and directly assigned to portions of the text.

In another implementation, audio files are indirectly assigned to portions of the text. Tags, such as words or other labels, are associated with portions of the text. Such tags may be stored in a computer data file or database and associated with the electronic book, similar to the cue list described above. Corresponding tags also are associated with audio files. One or more composers write and record original music that is intended to evoke particular emotions or moods. Alternatively, previously recorded music can be selected. These audio files also are associated with such tags, and can be stored in a database. The tags associated with the portions of the text can be used to automatically select corresponding audio files with the same tags. In the event that multiple audio files are identified for a tag in the book, one of the audio files can be selected either by a computer or through human intervention. This implementation allows audio files to be collected in a database, and the creation of a soundtrack to be completed semi-automatically, by automating the process of selecting audio files given the tags associated with the electronic book and with audio files.

In an implementation where audio files are indirectly associated with the electronic book, the audio files also can be dynamically selected using the tags at a time closer to playback.

The process of associating tags with the electronic book also can be automated. In particular, the text can be processed by a computer to associate emotional descriptors to portions of the text based on a semantic analysis of the words of the text. Example techniques for such semantic analysis include, but are not limited to, those described in “Emotions from text: machine learning for text-based emotion prediction,” by Cecilia Ovesdotter Alm et al., in Proceedings of Human Language Technology Conference and Conference on Empirical Methods in Natural Language Processing (October 2005), pp. 579-586, and which is hereby incorporated by reference. These tags can describe the emotional feeling or other sentiment that supports the section of the work being viewed. For example these emotional feelings can include, but are not limited to, medium tension, love interest, tension, jaunty, macho, dark, brooding, ghostly, happy, sad, wistful, sexy moments, bright and sunny.

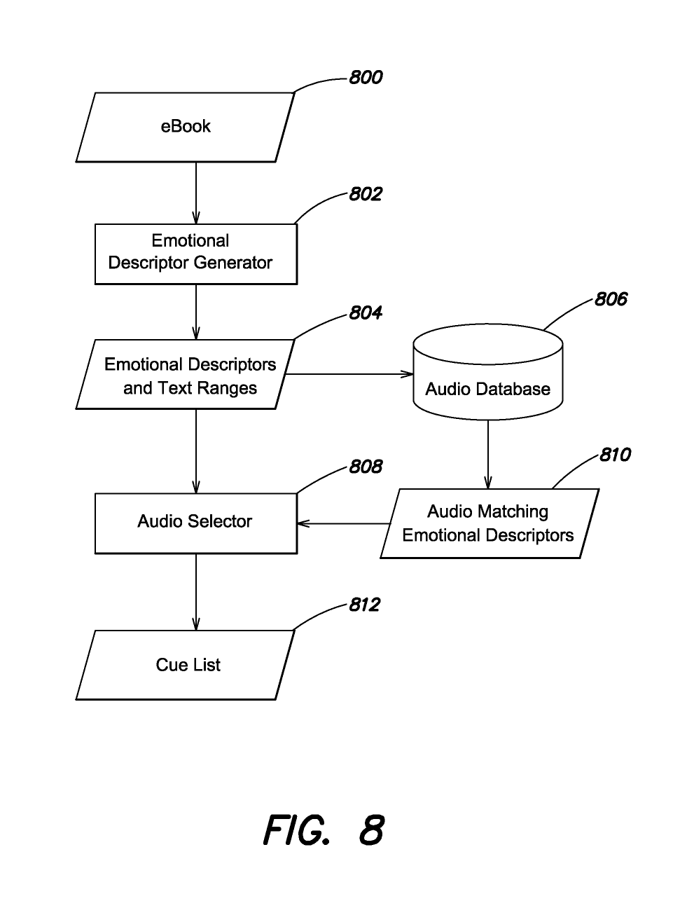

FIG. 8 is a data flow diagram that illustrates an example of a fully automated process for creating a soundtrack for an electronic book, given audio files that have tags associated with them. An electronic book 800 is input to an emotional descriptor generator 802 that outputs the emotional descriptors and text ranges 804 for the book. The emotional descriptors are used to lookup, in an audio database 806, audio files 810 that match the emotional descriptors for each range in the book. The audio selector 808 allows for automated, random or semi-automated selection of an audio file for each text range to generate a cue list 812. A unique identifier can be generated for the electronic book and stored with the cue list 812.

Such electronic books and their soundtracks can be distributed in any of variety of ways, including but not limited to currently used ways for commercial distribution of electronic books. In one implementation, the electronic book and the electronic book reader are distributed to end users using conventional techniques. The distribution of the additional soundtrack and dynamic audio player is completed separately. The distribution of the soundtrack is generally completed in two steps: first the cue list is downloaded, and then each audio file is downloaded. The audio files can be downloaded on demand. The dynamic audio player can include a file manager that maintains information about available cue files that may be stored on the same device on which the electronic book reader operates, or that may be stored remotely.

In one implementation, the electronic book is distributed to end users along with the cue list and dynamic audio player.

In another implementation, the electronic book and its associated cue list are distributed together. The cue list is then used to download the audio files for the soundtrack as a background task. In one implementation, the electronic book is downloaded first and the download of the cue list is initiated as a background task, and then the first audio file for the first cue is immediately downloaded.

In another implementation, the electronic book reader is a device with local storage that includes local generic cues, having a variety of emotional descriptors that can be selected for a playback in accordance with the cue list. These generic cues would allow playback of audio if a remote audio file became unavailable.

In one implementation, the electronic book reader application is loaded on a platform that has access to a network, such as the Internet, through which it can communicate with a distributor of electronic media. Such a distributor may receive a request to purchase and/or download electronic media from users. After receiving the request, the distributor may retrieve the requested work and its accompanying soundtrack information from a database. The retrieved electronic media can be encrypted and sent to the user of the electronic book reader application. The electronic media may be encrypted such that the electronic media may be played only on a single electronic book reader. Typically, the digital rights management information associated with the work also is applied to the soundtrack information.

### Providing for Unified Presentation and Consumption of Audio and Visual Content

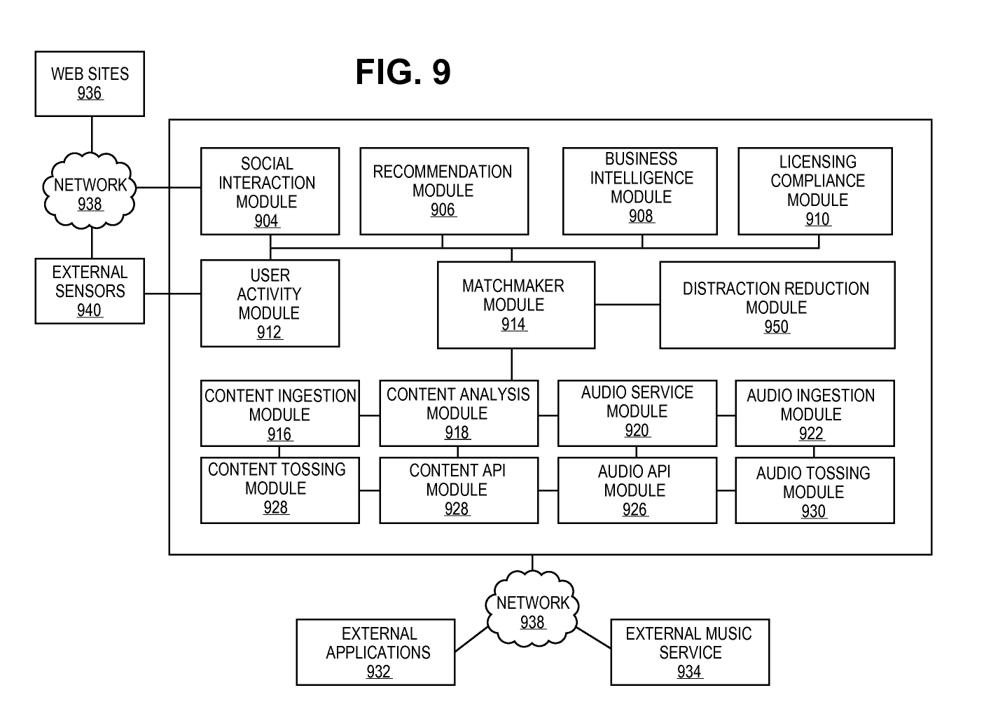

FIG. 9 is a block diagram 900 illustrating an example system 902 for the presentation and/or delivery of audio works that may be consumed along with electronic content, as well as an example system for the authoring of such combined works that may be delivered to an external device, as described further herein. The example system 902 may be implemented as executable software or hardware, and may be implemented on a general purpose computing device, on one or more separate devices which may or may not be communicatively coupled, on a network-accessible web service or otherwise made available over a communications network, or in some other format. Example system 902 may be comprised of one or more modules, each of which may be communicatively coupled to other modules, as well as capable of receiving and/or transmitting information to or from external sources, for example over a network such as the Internet.

Social Interaction Module 904 operates in one example to enable the transfer of data between system 902 and various social media websites/networks 936, such as Facebook, Twitter, LinkedIn, and the like. In an embodiment, Social Interaction Module 904 stores information allowing data stored in various modules of system 902 to be transmitted to social media networks 936. This may include storing information related to each social media network's API, as well as authentication information and text to be posted to the social media network 936. For example, Social Interaction Module 904 may access data related to a particular book (or any other type of content envisioned in the present disclosure, such as a word processing document, a web page, or other type of content) read by a user or an audio track that is “liked” by a user and transmit this data to a social network for automated posting on the social media network. This data may be stored by other modules, such as hereinafter-described User Activity Module 912. For purposes of the present disclosure, “social media networks” may be any website wherein users interact with data shared by other users.

Recommendation Module 906 operates in one example to provide suggested audio tracks for a user. Recommendation Module 906 may access data stored by another module, such as User Activity Module 912, and utilize this information to determine an appropriate recommendation. For example, Recommendation Module 906 may receive data describing a particular audio track that has been “liked” by a user a certain number of times, or that has been skipped or “disliked.” Recommendation Module 906 may also access data stored on an external source as part of the recommendation logic. For example, Recommendation Module 906 may connect to a user's personal music library (e.g., over a network to a laptop computer on which the music library is stored) and access data describing which songs the user has played the most or which have been given a high “ranking” by the user. Recommendation Module 906 may also connect over the Internet to an external music service to obtain data used for recommendations; for example, to a user's Spotify or Pandora account. Recommendation Module 906 may also utilize functionality embodied by Social Interaction Module 904 to access social networks to obtain data used for recommendations.

Business Intelligence Module 908 operates in one example to receive and store data related to a user's preferences. For example, Business Intelligence Module 908 may receive data describing which e-books and/or audio tracks a user is consuming (e.g., the frequency of said consumption, the speed of said consumption, etc.). Business Intelligence Module 908 may in one example utilize information from User Activity Module 912 and/or Recommendation Module 906 in order to predict user behavior, such as preferences for particular audio and/or other content.

Licensing Compliance Module 910 operates in one example to determine compliance with various laws and regulations concerned with the copying and access to copyrighted material, such as songs and books. For example, for a particular piece of music, Licensing Compliance Module 910 may communicate with a separate module and/or server (e.g., a database) in order to determine whether the piece of music has been licensed for use. Licensing Compliance Module 910 may also operate, in one example in conjunction with a separate module and/or server, to track usage of particular music and/or content to confirm compliance with licensing terms; for example, royalty payments may depend on the number of times a particular piece of music is played (or geographic location of the plays, etc.), and this information may be updated, monitored and stored via commands utilized by Licensing Compliance Module 910.

User Activity Module 912 operates in one example to monitor and store data describing all interaction between a user and electronic media. For example, the User Activity Module 912 provides functionality to receive data 114 about the user interaction with the electronic book reader 112, as well as cues 120 and the cue list 118, as described with reference to FIG. 1 and subsequent figures. User Activity Module 912 in additional examples also provides functionality for the dynamic audio player 116 to use the user interaction data 114 and the cue list 118 to select the audio cues 120 to be played, and when and how to play them, to provide an output audio signal 122. User Activity Module 912 may also provide the functionality to track a user's reading speed, as described previously.

In an embodiment, any interaction between a user of system 902 and any portion of system 902 is tracked by User Activity Module 912, and the data generated as a result is utilized by other modules of system 902. For example, a user may be reading an e-book on an external e-reading device, for which an audio track has been selected and is playing, as described previously. The user may activate a user interface element that indicates the user “liked” the audio track (i.e., she wants to hear more audio tracks like the presently-playing one, or wants to hear that audio track more often as time goes on). In another example, the user may “skip” the audio track. Data generated by the “like” or the “skip” is transmitted to User Activity Module 912 and stored. The data may be transmitted to Recommendation Module 906 for future use in recommending an audio track (or not recommending that particular audio track, as the case may be).

In an embodiment, User Activity Module 912 may be communicatively coupled to Sensors 940 and receive data indicative of user activity; for example, GPS data about location of use, ambient sound information from a microphone, visual data from a camera (for example, tracking eye movement), device movement from a gyroscope, etc. This data may be processed and/or utilized by User Activity Module 912 or communicated with other modules (such as Distraction Reduction Module 950) and/or entities.

In another embodiment, Social Interaction Module 904 may connect to Facebook and receive data indicating that a user of system 902 has “liked” a song or book posted on another user's profile (or “page”). This data may be transmitted to User Activity Module 912, for example to be used by Recommendation Module 906 for future use in recommending an audio track or electronic content such as an e-book.

Content Ingestion Module 916 operates in one example to enable functionality for processing various items of content to be consumed (e.g., e-books, websites, e-mails, PDF documents, etc.). In an example embodiment, Content Ingestion Module 916 receives an e-book as input and analyzes the text in order to determine aspects of the content. For example, a book with a narrative story has various “affective” values associated with the story; these values, taken as a whole, describe the emotional coordinates of the book. One portion of the book may contain text that evokes emotions of fear, while another portion evokes a happy emotion. This process is also described above with reference to FIG. 8, where an electronic book 800 is input to an emotional descriptor generator 802 that outputs the emotional descriptors and text ranges 804 for the book. Modules such as Content Ingestion Module 916 and/or Content Tagging Module 928 may operate as the aforementioned emotional descriptor generator. This process may be used in alternate embodiments to provide similar functionality for content such as web pages, e-mails, or any document containing text.

In an embodiment, Content Ingestion Module 916 operates in coordination with Content Tagging Module 928 to associate tags, such as words or other labels stored in Content Tagging Module 928, with portions of the content, as described more fully above. Content Tagging Module 928 may in some embodiments perform the functionality ascribed above to Content Ingestion Module 916, while Content Ingestion Module 916 may simply operate to receive external content and transmit it to Content Tagging Module 928.

In an embodiment, Content Tagging Module 928 may provide a user interface for manually associating tags with content. For example, an administrator of system 902 may log into Content Tagging Module 928 and assign tags stored in Content Tagging Module 928 to portions of the content as ingested by Content Ingestion Module 916. In addition to the manual approach, Content Tagging Module 928 may operate automatically to perform aforementioned semantic analysis of the words of the content and intelligently assign appropriate tags to portions of the content.

Content API Module 924 operates in one example to provide an application programming interface (API) in order that information and instructions may be exchanged between elements of the system, such as an electronic book reader and the dynamic audio player, as described more fully above.

Content Analysis Module 918 operates in one example to interface with the Matchmaker Module 914, described more fully hereafter, in various embodiments to provide data describing aspects of the content to be consumed, which then is utilized by Matchmaker Module 914 to “match” particular audio tracks having certain characteristics to the content to be consumed based on the aspects of the content. In one example, Content Analysis Module 918 analyzes content based on semantic and word analysis to determine particular aspects of the content. For example, Content Analysis Module 918 may operate to determine affective and/or emotional values of literary works, either with manual input or automatically. Also, Content Analysis Module 918 may operate to determine that the content in question is a web page and analyze the text of the web page to determine aspects of the content; for example, that a user is browsing a shopping site, a news site, or an entertainment site. In this manner, aspects of the content are driven to Matchmaker Module 914; for example, if a user is browsing a web page with “sad” or otherwise affective content, Matchmaker Module 914 could utilize this data to select appropriate music to accompany the content.

Audio Ingestion Module 922 operates in one example to perform back-end functions to import audio, for example into a database. In one embodiment, audio processed via this module is analyzed for characteristics such as valence, musical key, intensity, arrangement, speed, emotional values, recording style, etc. Metadata associated with the audio (e.g., ID3 tags) may also be analyzed by this module.

Audio Tagging Module 930 operates in one example to associate metadata (e.g., tags) with audio, in an example driven by data received from Audio Ingestion Module 922. Tags may be manually or automatically associated with audio, which are then stored, for example in a database.

Audio API Module 926 operates in one example to provide an application programming interface (API) in order that information and instructions may be exchanged between elements of the system, such as an electronic book reader and the dynamic audio player, as described more fully above.

Audio Service Module 920 operates in one example to interface with External Music Services 932; for example, Spotify, Rhapsody, Pandora, etc. In an example, Audio Service Module 920 may receive and interpret commands and/or data between various modules and External Music Services 932. For example, Audio Service Module 920 may facilitate transfer of audio data between External Music Services 932 and Audio Ingestion Module 922. Further, Audio Service Module 920 may facilitate the transfer of data between a database (in one example stored on an external server) that contains data describing audio (for example, processed by Audio Ingestion Module 922 and/or Audio Tagging Module 930) and other modules, such as Matchmaker Module 914. Audio Service Module 920 may in an example embodiment analyze and store extended meta values for audio available to the system; for example, a database of songs and their audio qualities such as valence, arousal, major key, instrumentation, and the like.

Matchmaker Module 914 operates in one example to receive and analyze data related to user activity (e.g., from User Activity Module 912), content (e.g., from Content Analysis Module 918), and/or audio (e.g., from Audio Service Module 920). This data is analyzed in order to determine appropriate matches based upon what a user is doing, content a user is consuming, and available audio to associate with the content. For example, Matchmaker Module 914 may take data indicating that a user is in a loud environment (e.g., from Sensors 940) and reading a book passage that is highly emotional. Matchmaker Module 914 communicates with other system modules to select audio appropriate for the user's environment and the content being consumed. This decision-making process may be automated, for example via semantic rules and/or machine learning, or human-curated, for example by consulting associations between content and audio stored in a database.

External Applications 932 operates in one example as an API to applications that may be executing on another system. In some examples, a word processing program executing on a user's laptop, a book reading app on a mobile device, a web browser executing on a tablet, etc.

External Music Services 934 may comprise any source of audio external to the system as described herein. For example, it may comprise music stored on a user's system (such as an iTunes library on a laptop or mobile device) as well as Internet-based music systems such as Spotify, Rhapsody, Pandora, etc.

Sensors 940 may in various embodiments comprise external sources of data, such as a microphone, GPS device, camera, accelerometer, wearable computing devices, and the like. Some or all of the sensors may be located within a device that is executing aspects of the system described herein; for example, a mobile device may be utilizing aspects of the concepts described herein and in that example Sensors may comprise the mobile device's microphone, camera, accelerometer, etc., while also comprising devices communicatively coupled to the mobile device.

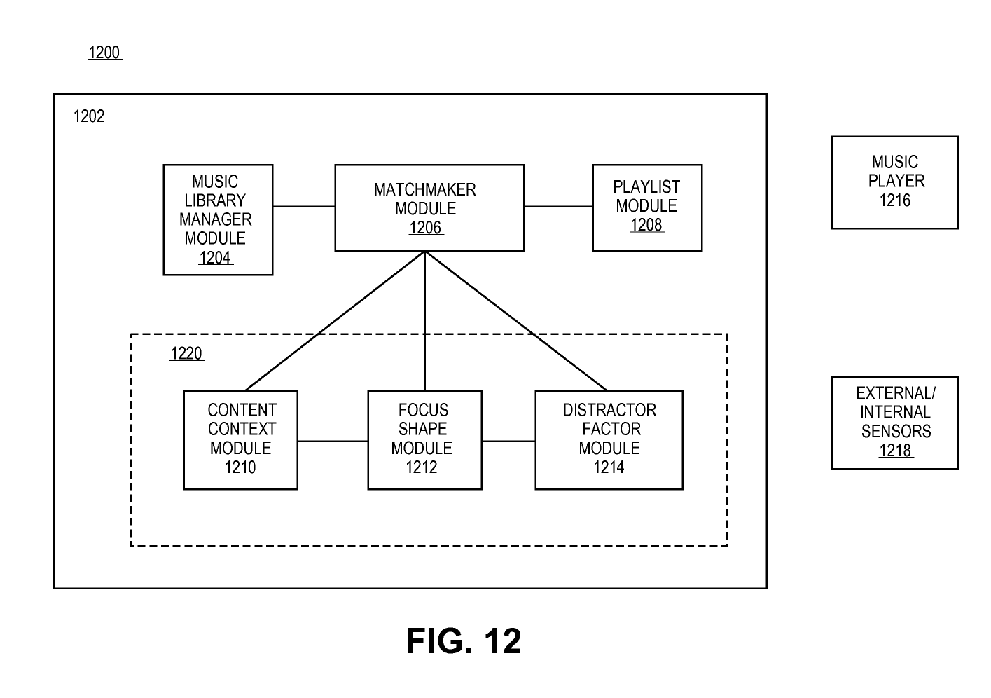

Distraction Reduction Module 950 may comprise a module corresponding to the description associated with element 1202 of FIG. 12 below, or may have a subset of the aspects of FIG. 12.

Aspects of the example system described with reference to FIG. 9, as well as the description above, may in an embodiment operate to determine emotional values for an electronic visual work (e.g., e-book, web page, word processing document, e-mail, etc.), as well as an audio work such as a song. For example, Content Ingestion Module 916 and/or Content Service Module 918 may utilize tools known in the art to automatically process text and determine affective/emotional values for the text. Human-curated values may be used as well. In an example, Audio Ingestion Module 922 and/or Audio Service Module 920 may operate to determine emotional values, as well as extended meta values, for songs.

Emotional descriptors (e.g., tags) may be associated with sections of the electronic visual work; for example, a portion of the electronic visual work that is determined to be “sad” may be “tagged” with a descriptor corresponding to a “sad” value; similarly, a portion of the electronic visual work that is determined to be “happy” may be “tagged” with a descriptor corresponding to a “happy” value. The sequence of the emotional descriptors associated with the electronic visual work may be described by a mapping or similar data structure and the mapping associated with the electronic visual work, for example in a database or as metadata stored in the file itself.

Emotional descriptors (e.g., tags) may be associated with sections of the audio work; for example, a portion of a song that is determined to be “sad” may be “tagged” with a descriptor corresponding to a “sad” value; similarly, a portion of a song that is determined to be “happy” may be “tagged” with a descriptor corresponding to a “happy” value. The sequence of the emotional descriptors associated with the electronic visual work may be described by a mapping or similar data structure, and the mapping associated with the audio work, for example in a database or as metadata stored in the file itself.

In an embodiment, Matchmaker module 914 may receive a request to match an audio work to an electronic visual work, and the request may include additional information such as a type. In performing the request, Matchmaker module 914 may compare the mappings for the audio work and the electronic visual work, and based on the comparison, determine an audio work responsive to the request where the audio work corresponds to the type. Examples of “types” may include such information as music genre, speed of the music (BPM, etc.), or any type of property of the music (e.g., extended meta values).

In an embodiment, a portion of text may be copied to a buffer and processed locally using techniques described herein or transmitted to a server to be processed there. The text is analyzed in a process that looks for several types of data; for example, themes, geography, emotional values, instructional content, etc. If the text was copied from a web page, then the metadata for the page may be analyzed, along with any domain information and HTML/CSS data. A “meta map” of the content is created, and then matched (e.g., using Matchmaker module 914) to a playlist of appropriate music. For example, if the text is from a web page for a retail shopping site about classic cars, a playlist with an appropriate theme will be delivered, such as rockabilly music. If the web page were about yoga, then a playlist of gentle new age music could be provided.

The text, web page, book or document (“document”), is received and divided into partitions, logical or otherwise. Each partition corresponds to an identifier, and a document mapping is created based on the identifiers. The document mapping is compared with similar mappings for audio works, mappings such as described in detail above. Based on the comparison, a playlist of audio works is generated where the audio mapping of each audio work corresponds to the document mapping.

In an example embodiment, text analysis is performed on an electronic visual work to determine whether it has “affective values.” If not, then the electronic visual work is assumed to be an instructional work. In an example, further analysis is performed on the electronic visual work to determine where the summaries of the information are located. These are typically toward the end of chapters. Meta tag markers are then created based on word counts or other data, which markers correspond to “high-density information” in the electronic visual work. When a reader gets to these marked sections, the accompanying audio, provided as described in this disclosure, is processed through DSP or other means to change the sound of the audio in various ways. These can include adding audio brainwave training frequencies, changing the music programming to that having different properties, or other approaches such as subtly altering the EQ or compression. In this manner, a form of audio highlighting for dense informational passages may be obtained, which may positively impact a user's ability to recall the specific information later.

In an example embodiment, audio tracks are “round robined” in order to sustain a similar emotional quality over several different tracks, or from a contiguous selection of songs by analyzing the sections and cross-fading in and out of emotionally matching sections. In this manner, a continuous stream of music that has a similar affective value is created, allowing the approach to sustain a particular emotional quality for an extended period of time; for instance, when a user is a slower reader and each book tag needs to last longer.

A request is received for an audio work, for example to complement an electronic visual work. The audio work comprises sections corresponding to a particular emotional quality (or extended meta value), and each section is associated with an audio emotional descriptor. A first section of the audio is played, and the emotional quality of the audio corresponds to an emotional quality of the electronic visual work, for example using emotional descriptors (or tags). In the example that the reader does not reach a subsequent section of the electronic visual work (that has a different emotional quality), then a different audio selection that corresponds to the emotional quality of the currently-in-use section of the electronic visual work is played. Once the subsequent section of the electronic visual work is reached, then in an example embodiment, a new audio selection is chosen that corresponds to the emotional quality of the subsequent section of the electronic visual work.

### Adaptive Distraction Reduction

While music is traditionally used as entertainment in itself or along with other forms of media such as movies and books (as described above), music may also serve to enhance productivity and reduce distractions. People often listen to music while performing other tasks, such as pleasure reading, working and studying, in order to mask background noise and therefore reduce distractions from their environment.

One reason for environmental distractions lies in humans' evolutionary history. The limbic system of the brain served a purpose for our ancestors that is at odds with our fast-paced society. Its purpose was to be constantly scanning for stimuli in the background while a person engaged in other activity like eating, tending a fire, sharpening weapons, etc. If certain stimuli were detected, then the limbic system would send the neural equivalent of an interrupt signal to the frontal lobe, causing the brain to switch context from the task at hand to determining whether the received stimuli indicated a potential threat. The stimuli could be a noise, a smell, even a flash of color or movement in the leaves, any of which could indicate the presence of a mortal threat.

Mortal threats such as tigers, snakes, fire and invading tribes have little relevance in a coffee shop while one is reading a novel, but the limbic system continues to do its job despite the reality of our present-day environment. Therefore, there is a need for an approach to help distract the limbic system in order to allow a person to focus while noises, smells and visual stimuli assault their limbic system.

Scientific studies indicate that people can concentrate on a particular task for approximately 100 minutes on average before needing to take a break prior to beginning another concentration cycle. While this is an optimal result that is at odds with the reality of environmental distractions, it is possible for a person to reach a state of intense concentration where all external stimuli are minimized and a person's focus is at its peak. This is commonly referred to as “flow.” The term is commonly used in the context of sports; for example, a basketball player may enter a state of performance during a game where it seems as if every shot goes in. A baseball player may get on a “hot streak” where he tells reporters that each pitch to him looks as big as a grapefruit. A golfer may seem to sink every putt.

While this “flow” state of concentration exists in sports, it also is accessible to ordinary people doing everyday activities. A person reading in a coffee shop may enter a flow state (or “Vagus State”) during the 100-minute period of concentration. This “flow” state may be perceptible from an observable physiological standpoint. People in a flow state often evidence telltale physical signs such as subvocalization, lowered respiratory rate, head movements, leg “jiggling” or moving, etc. Certain brain wave activity may be associated with a flow state. This flow (or Vagus) state may be measured via sensors reflecting data about a person's physical state.

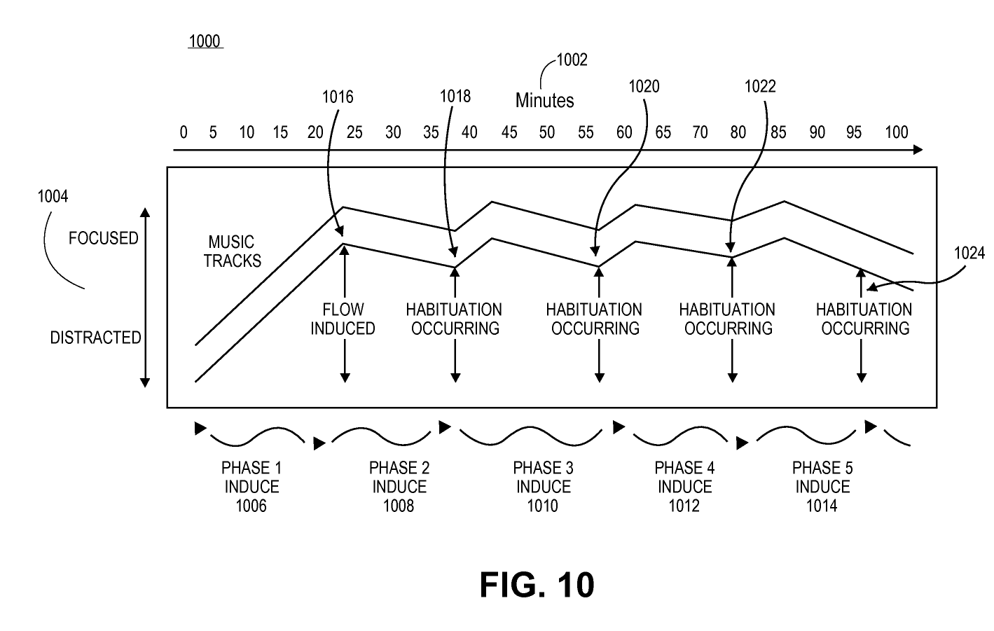

Once a person enters the standard 100-minute period of concentration, it takes a period of time to induce a flow state. During this period, the limbic system habituates to external stimuli, which allows a flow state to commence. FIG. 10 is a diagram 1000 illustrating an example representation of a productivity cycle with an embodiment of multiple phases of musical selections being played which are designed to sustain a flow state even as habituation to the musical selections is occurring. The vertical axis 1004 represents a level of focus, from “distracted” to “focused.” A value towards the “focused” end of the range indicates a higher level of flow state. The horizontal axis 1002 represents time in minutes.

The first phase 1006, in this example lasting from zero to approximately 20 minutes, represents the inducement of a flow state, in an embodiment caused by playing a selection of music tracks designed to calm the limbic system and induce the flow state, as discussed further herein. The musical selections are designed to calm the limbic system, much as background noise such as traffic or crickets in a quiet woodland house fades into the background after a period of time. After a flow state is induced 1016 by the musical selections, habituation begins to happen. As will be described further herein, each piece of music played in sequence during the five phases 1006-1014 shown in FIG. 10 has a specific role in enhancing an individual's focus and reading enjoyment. In an embodiment, characteristics such as musical key, intensity, arrangement, speed, emotional values, recording style and many more factors determine what is played where and when.

Turning back to FIG. 10, after the flow state is induced 1016, a “sustain” phase 1008 begins wherein an embodiment plays musical selections with specific characteristics designed to maintain the flow state. Usually, after approximately twenty minutes, habituation to the musical selections occurs 1018, which may be compared to the car noise or crickets mentioned earlier slowly disappearing from a person's conscious awareness. Without a change in the musical selections, the focusing effect of the music will lose its potency and the flow state will end. According to an embodiment, at each point where habituation to the musical selections may occur 1016-1022, musical selections are changed in order to allow the flow state to be sustained 1008-1014. Eventually, a habituation occurs which cannot be reversed 1024, and the flow state ends. This is commonly at the 100-minute mark. The person will need to take a break prior to starting a new 100-minute cycle.

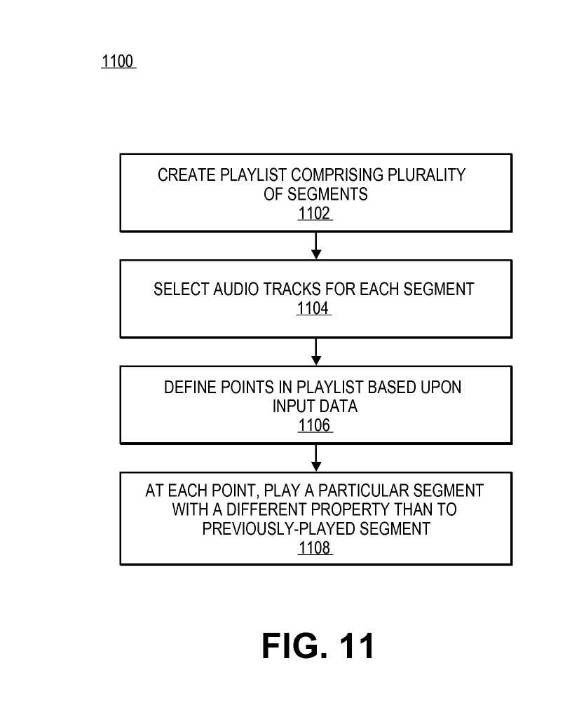

FIG. 11 is a flow diagram illustrating an example process 1100 for creating an audio playlist for distraction reduction. In some implementations, the process 1100 can include fewer, additional and/or different operations. In other examples, only one or some subset of these operations may be included, as each operation may stand alone, or may be provided in some different order other than that shown in FIG. 11.

At 1102, a playlist of audio tracks is created. While traditionally a playlist is a list of songs that are to be played in order, in one embodiment this playlist is a placeholder for audio tracks to be selected in subsequent steps; however, a traditional playlist may be utilized. In an embodiment, the playlist has discrete segments; for example, corresponding to the phases illustrated in FIG. 10.

At 1104, audio tracks are selected for each segment of the playlist, as described earlier. In an embodiment, the audio tracks selected for each segment are related to each other by at least one property of the musical composition making up the audio tracks. For example, each audio track selected for a particular segment may be in the same major key, or of the same tempo, or have the same instrumentation (e.g., flute vs. violin).

Audio may have “extended meta values” such as speed, tempo, key, valence, arousal, musical intensity, lead instrumentation, background instrumentation, supporting instrumentation, frequency range, volume description, stereo description, dynamic range, and/or dynamic range defined by valence and/or arousal.

At 1106, points in the overall playlist are defined at which each segment will begin playing. In an embodiment, each point is based upon input data. As an example, the points may be based upon time. Turning back to FIG. 10, the points may be understood as elements 1016-1022, each of which occurs at a particular point in time 1002. In other embodiments, the input data may be related to human factors that indicate a mental state related to concentration. For example, a user may be reading a book on an iPad and using embodiments of the present approaches to enhance concentration. The iPad camera may be used to monitor the user's eye movements, pupil dilation, lip movements, reading speed, and other criteria which are indicative of a user maintaining high concentration (e.g., being in a flow state). Based on the input data, it may be determined when a user is becoming habituated to the music; as a result, a point is defined where a new segment will begin playing in order to sustain the heightened state of concentration.

At 1108, at each defined point, a new segment is played. In an embodiment, the new segment contains music selections that are related to each other (as described above), but are different from the music tracks played as part of the previously-played segment. This allows for the titration of the habituation cycle, resulting in sustaining the user's concentration. By changing the music slightly as a user is going into habituation mode (see FIG. 10), a user is able to avoid habituation that leads to loss of flow state. Titration is related to the Distractor Factor value, as discussed below, and may be based on any type of data, such as time, physical data (EEG, heart rate, respiration, brain waves, etc.)

As discussed above, if input data allowing for the monitoring of a user's mental state is utilized in an embodiment, then the moment at which a subtle change in music selection should be enabled may be precisely determined, resulting in the smooth continuation of the user's concentration cycle.

FIG. 12 is a is a block diagram 1200 illustrating an example system 1202 for real-time adaptive distraction reduction, according to an embodiment. Elements of the described approach maintain a constant measurement of a user's degree of distraction at any given time while engaged in a task, such as reading. Based on this degree of distraction, as well as other data, music is selected and played in order to enhance the user's concentration levels, hopefully leading to a “flow state,” as described above. Once the user enters a high level of concentration, music is selected and played to maintain the flow state for as long as possible. Music is monitored and changed as a user is going into “habituation mode” in order to avoid habituation that leads to loss of flow state.

This real-time adaptive feedback loop analyzes how well a user is concentrating on a particular task at any given moment and builds a music playlist (which may be delivered to an external music player) designed to enhance and maintain concentration, or “flow.”

In an embodiment, a Distractor Factor value is calculated that describes a user's current state of concentration. In one example, the Distractor Factor value is a number between 0 (no distraction/high concentration) and 100 (high distraction/no concentration) that is continually calculated based upon various input data, as well as data related to the content that a user is consuming and the desired “focus shape,” which is discussed herein.

The Distractor Factor value is dynamically calculated in one example based upon numerous data, such as: heuristic reading speed; user's previous reading history (content, context, speed, etc.); camera data analyzing a user's eye movements and head motion, as well as helping to measure reading speed and reading style (e.g., does the user “double-back” over text after reading it); accelerometer data related to patterns of device movement, limb jerking, foot kicking, etc.; microphone data reflecting ambient noise, which can be used to determine location in lieu of GPS data (e.g., wind noise suggests a user is in a car); sensors such as heart rate monitors, respiration monitors, brain wave monitors may also be used, and may be deduced from sensors already present on a device (e.g., the camera may be able to detect slight skin movement related to heart rate), may be new sensors (e.g., a mobile device with a built-in heart rate monitor or brain wave scanner), or may connect, wirelessly or otherwise, to external sensors (such as wearable sensor devices like a Nike Fuel Band, FitBit, etc). Other inputs not listed here are envisioned, and the device may receive data from any type of sensor for use in the determination of the Distractor Factor value.

Metrics from different inputs, such as those above, are used to determine the Distractor Factor value. An embodiment then delivers a playlist of music that is intended to keep the Distractor Factor value within a range, which may be predetermined and may change depending on the context of the content being consumed and other data, such as a user's location. The “tightness” of the required concentration, or focus, is directly related to the modality of the reading task. For example, a person reading a manual on how to land a plane or perform intricate surgery will need to be completely focused (e.g., a Distractor Factor value near zero), while a person surfing entertainment or social media web sites does not need as intense a focus (e.g., a Distractor Factor value around 50-60).

Determining which music works best for particular content and focus shapes may be determined based on an initial setup testing a user's concentration levels based on different music properties and default settings (e.g., based upon other users' experiences, as described below), but is adaptively adjusted over time as more is learned about the user's reaction to different musical properties in various contexts. As the system determines which music tracks are actually reducing distraction (i.e., enhancing concentration or flow) in real-world situations, this information is stored and used moving forward. This data may also be transmitted to an external database and mined for use with other users; e.g., what tracks are working best under what conditions for which kind of user and which kind of reading modalities and focus shapes.

Turning back to the embodiment of FIG. 12, Distractor Factor Module 1214 receives input and calculates a Distractor Factor value based on this input that represents how much a user is distracted (i.e., not concentrating/not in flow) at any point in time. In one example, the Distractor Factor value is a number in a range between 0 (no distraction/high concentration) and 100 (high distraction/no concentration). The Distractor Factor value is a derived metric for an individual user updated in real-time based on, for example, the context of what the user is doing at any given moment, where they are physically (e.g., location and physical indicia such as heart rate), what they are trying to accomplish and what they have done recently. The Distractor Factor value may change over time depending on what the user is trying to accomplish, and the range of “acceptability” of the Distractor Factor value is influenced by this task context, as well as previous user activity (such as activity type and temporal components like duration).

The Distractor Factor value is used in the music selection process, such as input to Matchmaker module 1206 that operates in one example to select music and or audio processing intended to reduce distraction and enhance concentration/flow. According to an embodiment, the goal of the system 1202 is to maintain Distractor Factor value within a particular range based on what the user is doing at any given time. This allows for the titration of the habituation cycle, resulting in sustaining the user's concentration. By the Matchmaker Module 1206 changing the music slightly as a user is going into habituation mode (see FIG. 10), a user is able to avoid habituation that leads to loss of flow state.

Distractor Factor Module 1214 may receive data from any number of sensors 1218 and data sources, both external and internal. This data may be communicated wirelessly and may be processed by additional modules prior to being utilized by Distractor Factor Module 1214. For example, a user may be reading on a laptop or other mobile device, and sensors internal or external to that device may transmit data that is ultimately received by Distractor Factor Module 1214. One example input is from a camera, such as a front-facing camera on a mobile device or a separate camera. Example input data from a camera that is used in the determination of the Distractor Factor value may be head placement/movement (is the user looking at the screen, is the user bobbing his head, which is indicative of a flow state), eye movement (what percent of time is the user looking at the screen, is the user engaging in eye movement indicative of reading, how fast is the user moving his eyes, blink rate), motion happening in the background (is the user is a highly distracting environment such as a busy café), and ambient light levels.

Another example input to Distractor Factor Module 1214 is from a microphone, such as on a tablet computing device or a separate music player being controlled by embodiments of the approach described herein. Example input data from a microphone that is used in the determination of the Distractor Factor value may be voice quality, ambient sound, subvocalizations, etc.

Another example input to Distractor Factor Module 1214 is from a device gyroscope/accelerometer, such as in a mobile phone that aspects of an embodiment of the system are executing on, or which may be communicatively coupled to a device executing aspects of the system. Example input data from a gyroscope/accelerometer that is used in the determination of the Distractor Factor value may be how much the device is moving and in what ways. Certain movements may be indicative of high concentration, as described earlier.

Another example input to Distractor Factor Module 1214 is from a GPS or other location detection approach, such as in a mobile phone that aspects of an embodiment of the system are executing on, or which may be communicatively coupled to a device executing aspects of the system. Example input data from a GPS or other location detection approach that is used in the determination of the Distractor Factor value may be where the device is located and how it is moving (is the user in a vehicle).

Another example input to Distractor Factor Module 1214 is from data related to the user, which may be stored in an external source such as a database, or stored in Distractor Factor Module 1214. Examples of this data may include a user's previous reading habits (e.g., reading speed for various types of content, reading patterns), what a user is reading, what type of reading the user is doing (pleasure or work), is the user reading a familiar author or source of content, how long a user has been engaged in the current reading task, etc.

Another example input to Distractor Factor Module 1214 is from initial setup and testing that may be done by a user, for example as part of a device setup process. For example, a user may be presented with varying types of text to read, along with various types of music having various musical qualities as described above, and be asked questions about their level of concentration at any given point. The user's concentration level (i.e., lack of distraction) may be measured during the setup process, for example through sensors as described above. Data gathered during a user's setup process may be utilized by Distractor Factor Module 1214 as part of the Distractor Factor value calculation.

Focus Shape Module 1212 operates in an embodiment to track and communicate the currently-relevant Focus Shape as part of the Distractor Factor value calculation, for example by communicating with Distractor Factor Module 1214. In an embodiment, a focus shape is a mathematical model of what a user's focal attention is engaged with at any point in time. Various reading modalities may have different “focus shapes.” There may be multiple kinds of optimal focus shapes depending on what a user is doing. In an embodiment, a focus shape may comprise a multi-dimensional mathematical representation that includes not only the type of content that the user is focusing on, but also describes associated related thoughts and mental processes that may be triggered based upon what the user's core attention is focused on.

Example focus shapes may include: Fiction/Entertainment; Study/Nonfiction; Work; Instructional; Shopping/Retail; Social Networking/Email; and many potential others, defined by the type and/or level of attention/focus/lack of distraction desired for optimal performance. This list is not exhaustive, and any type of focus shape may be defined based upon various criteria. Some focus shapes may have overlapping aspects with other focus shapes.

For example, when a user is reading for pleasure (i.e., Fiction/Entertainment), a user is being entertained, with the optimal focus process being to read the words and create images in her mind. When being led by an intriguing plot, the focus shape is about maximizing a user's sense of intrigue or appreciation for the characters or story development.

Matchmaker Module 1206 in one example receives data indicating the desired or optimal focus shape from Focus Shape Module 1212, and this data is utilized in the creation and delivery of music playlists designed to maintain the Distractor Factor value in a particular range (said range being calculated in one example by the desired focus shape). For example, extreme tightness of focus (such as lack of distraction) is not always an absolute requirement as it may involve high levels of effort and mental stress (such as doing brain surgery or landing a plane), whereas reading a recipe or checking email typically requires much less concentration. Aspects of the described system operate jointly to determine the appropriate range of focus for a given activity and choose music to maintain that focus, all while continuously monitoring the user's focus level to change the music if necessary to avoid habituation. Matchmaker module 1206 as described with reference to FIG. 12 may comprise aspects of the Matchmaker module 914 described with respect to FIG. 9.

The changes over a given period of the focus shape may be different for each modality, depending on how long and what the user is doing. For example, checking to see if any new email has arrived takes a quick burst of attention, but then writing a complex message to a supervisor requires a different set of attention criteria. Doing web research into camping equipment for a family excursion used a more relaxed sustained focal attention.

Focus Shape Module 1212 may also utilize data such as user preferences or user settings; for example, a user may select a particular focus shape, and data from an initial setup (as described above) may be used. Other data may include time spent on the current task, content sources, how the user is consuming the information (e.g., reading on a small mobile device may require a different focus shape than reading on a large screen), etc.

Content Context Module 1210 operates in an embodiment to determine the reading modality (what a is user consuming), which in an embodiment is used by Focus Shape Module 1212. Content Context Module 1210 in one example determines the context of the reading content being consumed by the user, for example via machine analysis of text or manual selection. Content Context Module 1210 is an embodiment analyzes the text on a “page” along with any metadata and/or other available information (such as the source HTML file in the case of web browsing) to determine the content context. Is the user reading a blog page, doing online banking, reading a fiction novel, etc. In an example, Content Context Module 1210 may perform a web search using terms in the content to help determine the context, or may look to other data such as domain names, book titles, authors, etc.

In one example, a book's cue list (described above) or book “content map” defining where music cues should fall based on word count and emotional values are used to determine context.

Matchmaker Module 1206 in one embodiment operates to receive data from various modules and based on that data, select the most appropriate music track that best supports a user's concentration at the time. The Distractor Factor value drives the direction of the musical selection; for example, whether the music needs to increase, decrease, sustain or change the user's focal attention. Matchmaker Module 1206 in an example communicates with Music Library Manager Module 1204, which controls access to and communication with a music library, Playlist Module 1208, which controls the assembly and maintenance of playlists, such as which music is next to be played according to the desired level of focus needed for the user, and a Music Player 1216, which may be external or internal to the example system. For example, Music Player 1216 may be an iPod, iPhone, or stereo system.

In an example, in order to increase a user's focus (reduce distraction/enhance flow), the next piece of music selected for a phase may have an increased valence and/or speed, with more intensity in a major key that is more than one major key away. Generally, more intense and faster music operates to increase a user's focus; however, this may be influenced by a particular user's reactions to certain musical qualities, which may be determined during the initial setup/learning phase as described herein. During a setup phase, the system may determine what particular musical qualities (extended meta values) operate to increase, decrease, sustain or change the user's focal attention, as well as analyze the content context for each of these (one piece of music or musical quality may increase a user's focus for browsing the web, but not reading an instruction manual).

Music Library Manager Module 1204 in an example may also operate to assist in matching music to drive the Distractor Factor value. By utilizing the extended meta values associated with music available to Music Library Manager Module 1204 (such as in a user's music library or via an external music service such as Spotify, etc.), Music Library Manager Module 1204 may operate to store and analyze what a user's behavior was in the past when a particular piece of music was played, as well as the context of the content being consumed; e.g., did the user's focus increase, decrease or maintain, and what was the user doing?

Music Library Manager Module 1204 in an example may also operate to determine and store data related to a user's state when a piece of music begins and when it ends. For example, did the user's focus increase, decrease or maintain? This data may be transmitted to a database and information from multiple users may be aggregated in order to determine the suitability for various pieces of music in various contexts, and this data may be transmitted back to an example system in order to update information to be used for a particular user in the future. For example, data from other users may indicate that a particular musical selection works well to maintain focus when a user is reading fiction. This information may be transmitted to Music Library Manager Module 1204, which then updates its information to suggest that particular musical selection the next time the user is reading fiction. This is deducing the effect of music for a particular user based upon aggregated data from other users.

In an embodiment, matching the focus shape to the reading task is key to getting a user in the proper focus zone and keeping them there. Aspects of the system may drive rest breaks and mental exercises as needed to sustain focus, as well as generating and storing individual settings regarding how much and how long focus can be maintained in a single session. Music selections are evaluated for how well they operate to sustain user focus given a particular focus shape, and Matchmaker Module 1206 selects music and audio processing based on each user's settings.

As relates to FIG. 10, the approaches described above operate to induce flow, sustain focus, and avoid habituation. In an example, a 20-minute phase 1006-1014 may comprise 4-5 musical selections. The music extended meta values are used, for example by Matchmaker Module 1206, to select music appropriate for the sustaining of a user's flow state/concentration/lack of distraction. In an example, if a piece of music beginning a phase has a flute as a lead instrumentation, the subsequent pieces of music chosen for the phase should be related, for example by having a woodwind instrument as the lead instrumentation. Further, the key changes for music within a phase are optimally with the cycle of 5ths and are related, according to music theory. Within a phase, musical selections, as determined by meta values and other data, should be related with regard to speed, valence, arousal, etc.

When a habituation point is reached such that a different musical selection (i.e., having different musical qualities) is required to avoid habituation, an optimal choice is a piece of music in a different major key. The desired result is that a user's limbic system notices the different music over time but does not raise the difference to the level of mental focus. The change should not be noticeable by the user, but operate on a subconscious level.

In an embodiment, the Distractor Factor value is based upon inputs and is a constantly updated factor that represents how distracted a user is at any point is time. This also represents a user's focus, or “flow state” status.

In FIG. 12, Distractor Factor Module 1214 may comprise some or all of the elements described with regard to FIG. 12. For example, element 1220 may be a single module comprising the properties ascribed to elements 1210, 1212 and 1214, and may include other elements such as 1204 and/or 1208.

### Alternate Implementations

In this description an electronic book and an electronic book reader are used as examples of the kind of multimedia work and corresponding viewer with which playback of a soundtrack can be synchronized. Other kinds of multimedia works in which the duration of the visual display of a portion of the work is dependent on user interaction with the work also can use this kind of synchronization. The term electronic book is intended to encompass books, magazines, newsletters, newspapers, periodicals, maps, articles, and other works that are primarily text or text with accompanying graphics or other visual media.

In the following description, specific details are given to provide a thorough understanding of the embodiments. However, it will be understood by one of ordinary skill in the art that the embodiments may be practiced without these specific details. For example, software modules, functions, circuits, etc., may be shown in block diagrams in order not to obscure the embodiments in unnecessary detail. In other instances, well-known modules, structures and techniques may not be shown in detail in order not to obscure the embodiments.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc., in a computer program. When a process corresponds to a function, its termination corresponds to a return of the function to the calling function or a main function.

Aspects of the systems and methods described below may be operable on any type of general purpose computer system or computing device, including, but not limited to, a desktop, laptop, notebook, tablet or mobile device. The term “mobile device” includes, but is not limited to, a wireless device, a mobile phone, a mobile communication device, a user communication device, personal digital assistant, mobile hand-held computer, a laptop computer, an electronic book reader and reading devices capable of reading electronic contents and/or other types of mobile devices typically carried by individuals and/or having some form of communication capabilities (e.g., wireless, infrared, short-range radio, etc.).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

In the foregoing, a storage medium may represent one or more devices for storing data, including read-only memory (ROM), random access memory (RAM), magnetic disk storage mediums, optical storage mediums, flash memory devices and/or other machine readable mediums for storing information. The terms “machine readable medium” and “computer readable medium” include, but are not limited to portable or fixed storage devices, optical storage devices, and/or various other mediums capable of storing, containing or carrying instruction(s) and/or data.

Furthermore, embodiments may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, circuit, and/or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

Example embodiments may be implemented in digital electronic circuitry, or in computer hardware, firmware, or software, or in combinations thereof. Example embodiments may be implemented using a computer program product (e.g., a computer program tangibly embodied in an information carrier in a machine-readable medium) for execution by, or to control the operation of, data processing apparatus (e.g., a programmable processor, a computer, or multiple computers).

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communications network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a field programmable gate array (FPGA) or an application-specific integrated circuit (ASIC)).

The computing system can include clients and servers. While a client may comprise a server and vice versa, a client and server are generally remote from each other and typically interact through a communication network. The relationship of client and server arises by virtue of computer programs running on their respective computers and having a client-server relationship to each other. In embodiments deploying a programmable computing system, it will be appreciated that both hardware and software architectures may be considered. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set forth hardware (e.g., machine) and software architectures that may be deployed in various example embodiments.

One or more of the components and functions illustrated the figures may be rearranged and/or combined into a single component or embodied in several components without departing from the invention. Additional elements or components may also be added without departing from the invention. Additionally, the features described herein may be implemented in software, hardware, as a business method, and/or combination thereof.

While certain exemplary embodiments have been described and shown in the accompanying drawings, it is to be understood that such embodiments are merely illustrative of and not restrictive on the broad invention, having been presented by way of example only, and that this invention is not be limited to the specific constructions and arrangements shown and described, since various other modifications may occur to those ordinarily skilled in the art.

In the foregoing specification, example embodiments have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” “third,” and so forth are used merely as labels and are not intended to impose numerical requirements on their objects.

The Abstract of the Disclosure is provided to comply with 37 C.F.R. §1.72(b), requiring an abstract that will allow the reader to quickly ascertain the nature of the technical disclosure. The Abstract is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

### Hardware Mechanisms

An electronic book reader, or other application for providing visual displays of electronic books and other multimedia works, can be implemented on a platform such as described in FIG. 13.

FIG. 13 is a block diagram that illustrates a computer system 1300 upon which an embodiment of the invention may be implemented. In an embodiment, computer system 1300 includes processor 1304, main memory 1306, ROM 1308, storage device 1310, and communication interface 1318. Computer system 1300 includes at least one processor 1304 for processing information. Computer system 1300 also includes a main memory 1306, such as a random access memory (RAM) or other dynamic storage device, for storing information and instructions to be executed by processor 1304. Main memory 1306 also may be used for storing temporary variables or other intermediate information during execution of instructions to be executed by processor 1304. Computer system 1300 further includes a read only memory (ROM) 1308 or other static storage device for storing static information and instructions for processor 1304. A storage device 1310, such as a magnetic disk or optical disk, is provided for storing information and instructions.

Computer system 1300 may be coupled to a display 1312, such as a cathode ray tube (CRT), a LCD monitor, and a television set, for displaying information to a user. An input device 1314, including alphanumeric and other keys, is coupled to computer system 1300 for communicating information and command selections to processor 1304. Other non-limiting, illustrative examples of input device 1314 include a mouse, a trackball, or cursor direction keys for communicating direction information and command selections to processor 1304 and for controlling cursor movement on display 1312. While only one input device 1314 is depicted in FIG. 13, embodiments of the invention may include any number of input devices 1314 coupled to computer system 1300.

Embodiments of the invention are related to the use of computer system 1300 for implementing the techniques described herein. According to one embodiment of the invention, those techniques are performed by computer system 1300 in response to processor 1304 executing one or more sequences of one or more instructions contained in main memory 1306. Such instructions may be read into main memory 1306 from another machine-readable medium, such as storage device 1310. Execution of the sequences of instructions contained in main memory 1306 causes processor 1304 to perform the process steps described herein. In alternative embodiments, hard-wired circuitry may be used in place of or in combination with software instructions to implement embodiments of the invention. Thus, embodiments of the invention are not limited to any specific combination of hardware circuitry and software.

The term “machine-readable storage medium” as used herein refers to any tangible medium that participates in storing instructions which may be provided to processor 1304 for execution. Such a medium may take many forms, including but not limited to, non-volatile media and volatile media. Non-volatile media includes, for example, optical or magnetic disks, such as storage device 1310. Volatile media includes dynamic memory, such as main memory 1306.

Non-limiting, illustrative examples of machine-readable media include, for example, a floppy disk, a flexible disk, hard disk, magnetic tape, or any other magnetic medium, a CD-ROM, any other optical medium, a RAM, a PROM, and EPROM, a FLASH-EPROM, any other memory chip or cartridge, or any other medium from which a computer can read.

Various forms of machine readable media may be involved in carrying one or more sequences of one or more instructions to processor 1304 for execution. For example, the instructions may initially be carried on a magnetic disk of a remote computer. The remote computer can load the instructions into its dynamic memory and send the instructions over a network link 1320 to computer system 1300.

Communication interface 1318 provides a two-way data communication coupling to a network link 1320 that is connected to a local network. For example, communication interface 1318 may be an integrated services digital network (ISDN) card or a modem to provide a data communication connection to a corresponding type of telephone line. As another example, communication interface 1318 may be a local area network (LAN) card to provide a data communication connection to a compatible LAN. Wireless links may also be implemented. In any such implementation, communication interface 1318 sends and receives electrical, electromagnetic or optical signals that carry digital data streams representing various types of information.

Network link 1320 typically provides data communication through one or more networks to other data devices. For example, network link 1320 may provide a connection through a local network to a host computer or to data equipment operated by an Internet Service Provider (ISP).

Computer system 1300 can send messages and receive data, including program code, through the network(s), network link 1320 and communication interface 1318. For example, a server might transmit a requested code for an application program through the Internet, a local ISP, a local network, subsequently to communication interface 1318. The received code may be executed by processor 1304 as it is received, and/or stored in storage device 1310, or other non-volatile storage for later execution.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method for creating an audio playlist for distraction reduction, comprising:
creating a playlist of audio tracks, wherein the playlist comprises a plurality of segments;
selecting audio tracks for each segment, wherein the audio tracks comprising each particular segment are related to each other by at least one property of the audio tracks' musical composition;
defining points in the playlist at which each segment will begin playing, wherein each point is based upon input data; and
at each defining point, playing a particular segment wherein the at least one property of the audio tracks comprising the particular segment is different from the at least one property of the audio tracks comprising the previously-played segment.

2. The method of claim 1, wherein the input data comprises time.

3. The method of claim 1, wherein the at least one property comprises a musical key.

4. The method of claim 1, wherein the at least one property comprises instrumentation.

5. The method of claim 1, further comprising inserting a crossfade between each segment.

6. The method of claim 1, wherein the audio tracks comprising adjoining segments differ by a single key change.

7. The method of claim 1, wherein the audio tracks used to create the playlist share the same musical genre.

8. A computer-readable storage medium that tangibly stores instructions, which when executed by one or more processors, cause:
creating a playlist of audio tracks, wherein the playlist comprises a plurality of segments;
selecting audio tracks for each segment, wherein the audio tracks comprising each particular segment are related to each other by at least one property of the audio tracks' musical composition;
defining points in the playlist at which each segment will begin playing, wherein each point is based upon input data; and
at each defining point, playing a particular segment wherein the at least one property of the audio tracks comprising the particular segment is different from the at least one property of the audio tracks comprising the previously-played segment.

9. The computer-readable storage medium of claim 8, wherein the input data comprises time.

10. The computer-readable storage medium of claim 8, wherein the at least one property comprises a musical key.

11. The computer-readable storage medium of claim 8, wherein the at least one property comprises instrumentation.

12. The computer-readable storage medium of claim 8, further comprising instructions for:
inserting a crossfade between each segment.

13. The computer-readable storage medium of claim 8, wherein the audio tracks comprising adjoining segments differ by a single key change.

14. The computer-readable storage medium of claim 8, wherein the audio tracks used to create the playlist share the same musical genre.

15. A system for creating an audio playlist for distraction reduction, comprising:
a playlist creation module configured to create a playlist of audio tracks, wherein the playlist comprises a plurality of segments;
an audio track selection module configured to select audio tracks for each segment, wherein the audio tracks comprising each particular segment are related to each other by at least one property of the audio tracks' musical composition;
an audio playback module configured to:
define points in the playlist at which each segment will begin playing, wherein each point is based upon input data; and
at each defining point, play a particular segment wherein the at least one property of the audio tracks comprising the particular segment is different from the at least one property of the audio tracks comprising the previously-played segment.

16. The system of claim 15, wherein the input data comprises time.

17. The system of claim 15, wherein the at least one property comprises a musical key.

18. The system of claim 15, wherein the at least one property comprises instrumentation.

19. The system of claim 15, wherein the audio playback module is further configured to:
insert a crossfade between each segment.

20. The system of claim 15, wherein the audio tracks comprising adjoining segments differ by a single key change.

21. The system of claim 15, wherein the audio tracks used to create the playlist share the same musical genre.
